(19) United States
(12) Patent Application Publication
(10) Pub. No.: US 2004/0045747 A1
(43) Pub. Date: Mar. 11, 2004

(54) Drive for crawler track

(75) Inventors: Larry E. Albright, Gwinner, ND (US); Dan Frederick, Forman, ND (US)

Correspondence Address: Nickolas E. Westman, Westman, Champlin & Kelly, Suite 1600, 900 Second Avenue South, Minneapolis, MN, 55402-3319, US

(73) Assignee: Clark Equipment Company, Woodcliff Lake, NJ

(21) Appl. No.: 10/640,937

(22) Filed: Aug. 14, 2003

Related U.S. Application Data
(60) Provisional application No. 60/403,585, filed on Aug. 14, 2002.

(51) Int. Cl. B62D 55/00

(52) U.S. Cl. 180/9.1

(57) ABSTRACT

A speed reduction drive is used with a crawler track that is an endless member mounted on suitable supports including a ground engaging portion for moving a vehicle attached to a track frame. The speed reduction drive comprises a drive case having an input shaft and an output shaft. The output shaft has a pair of track drive wheel sections mounted on opposite ends thereof that protrude out from the drive case. The input shaft has a sprocket drivably mounted thereon and carrying a chain that drives a sprocket on the drive shaft. The input shaft is driven with a hydraulic motor and has a normally spring-applied pressure released brake on the input shaft. The track drive wheel sections have bars or drive elements that engage lugs on the track to effect the driving arrangement when the track drive wheel sections are rotated.

The present application is based on and claims the benefit of U.S. Provisional Patent Application Serial No. 60/403,685, filed Aug. 15, 2002, the content of which is hereby incorporated by reference in its entirety.

### BACKGROUND OF THE INVENTION

The present invention relates to a drive system for tracks on a crawler tractor that reduces the motor size necessary, and provides more efficient operation.

Traditional drives for crawler tractor tracks have used large drive motors directly driving the drive sprocket for a chain on the track along with large brakes needed for those motors. Large drive motors and large brakes are expensive, and difficult to mount.

Additionally, the large track drive sprocket that mounts onto the motor is expensive, and the loads involved require heavy bearing supports.

### SUMMARY OF THE INVENTION

The present invention relates to a low cost, easily made track drive system for crawler tracks, as shown, molded rubber tracks. The drive system includes a main housing or drive case that mounts within the track enclosure formed by the endless track. A drive motor mounts on the housing or box drives, through a speed reduction chain and supporting the track drive sprocket.

The output shaft, rotated by the driven sprocket, has ends that extend out from opposite sides of the main housing or drive case. A track drive wheel is mounted on the opposite ends of the output shaft. The track drive wheel is split into separate drive wheel sections. A track drive wheel section is mounted on each of the ends of the output shaft on opposite sides of the housing. The track drive wheel sections together form a track drive wheel for the rubber tracks that are shown and utilized.

The track drive wheel sections can be cast wheels with drive bars at the periphery that engage drive lugs on the tracks. Also wheel sections stamped from metal can be used. Additionally, track drive wheel halves make it easy to mount the track on the drive because an outer track drive wheel section can be removed at a time.

Additionally, the drive case or housing output shaft driven by the motor that drives the drive sprocket on the input end of the drive case or housing has a spring applied pressure released brake mounted thereon at an end opposite from the motor. The brake is secured to the drive case or housing, and will provide a braking action for the drive shaft whenever pressure is released.

The drive motor is protected from dirt that may be ingested through the output shaft seals, because of the space from the drive shaft to the output shaft in the chain drive case or housing. The chain drive case or housing can be internally lubricated and continuously flushed with drive motor leakage or drain oil, after which the oil can be filtered. There can be a pressure return of the motor case drain oil.

The rubber tracks that are used and shown all have lugs that are driven and can be guided by idler wheels and bogie wheels and that keep the track centered on the drive wheel sections. The drive wheel sections or halves have positive lug drive bars to engage the track lugs, so that the drive wheel drive bars engage the drive lugs on the track.

Since the chain drive case or housing is located between the track drive wheel sections or halves, the drive case will tend to clear mud that might otherwise stick to the center parts of the track drive wheel. The stationary chain case or housing thus reduces the amount of mud that would be carried with the drive wheels and packed around or into the drive track.

The stationary chain case or housing can be made of fabricated material, or cast, and is generally made into two sections that would be secured together with bolts or cap screws. The drive wheel can be made also as a cast member, or in fabricated sections, as desired. The drive wheel is split into two drive wheel sections, with bars on the periphery that will engage the lugs on a rubber track, and will serve to drive the track much like teeth on a sprocket.

The track can have lugs that are arranged transversely parallel to each other, straight across the track, or the lugs for each drive wheel section can be one half pitch to provide for drives from one of the drive wheels to a first row of lugs, and from the other drive wheel section to another longitudinally offset row of lugs. Steel drive tracks also can be driven with this driver arrangement, using suitable lugs on tracks.

### BRIEF DESCRIPTION OF THE DRAWINGS

FIG. 1 is a side elevational view of a portion of a drive track having a drive wheel and drive motor and chain case made according to the present invention installed thereon;

FIG. 2 is a sectional view taken as on line 2--2 in FIG. 1;

FIG. 3 is a perspective view of a modified form of the drive wheel sections of the present invention with parts broken away to show a chain drive;

FIG. 4 is a side elevational view of a further modified form of the present invention showing a track which is used with the speed reduction chain case of the present invention;

FIG. 5 is a sectional view taken generally along line 5--5 in FIG. 4;

FIG. 6 is a perspective view of the chain case of the present invention in the form used in FIG. 4;

FIG. 7 is an exploded view of the chain case of the present invention; and

FIG. 8 is a sectional view taken as on line 8--8 in FIG. 4; and

FIG. 9 is a schematic perspective view of the track assembly from an opposite side from FIG. 4.

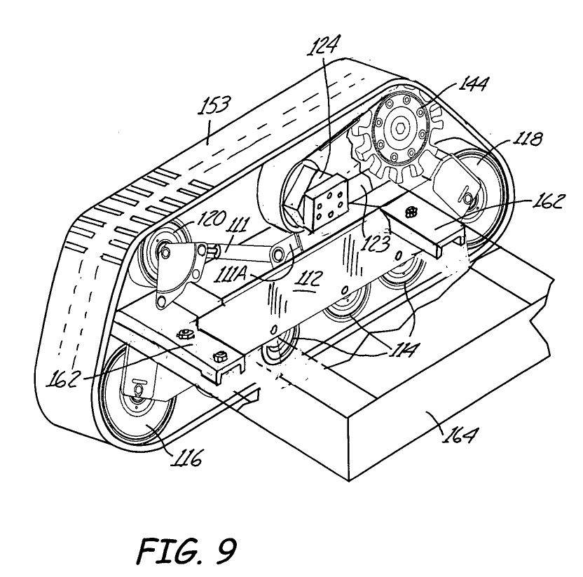

### DETAILED DESCRIPTION OF THE PREFERRED EMBODIMENTS

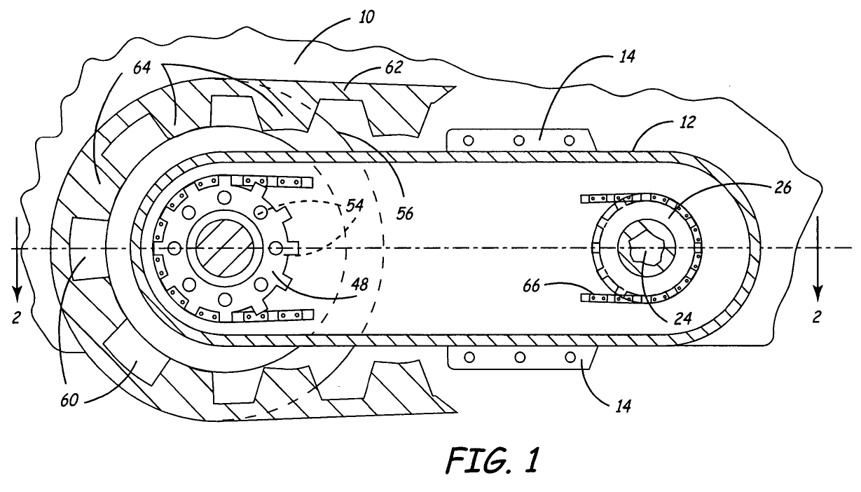

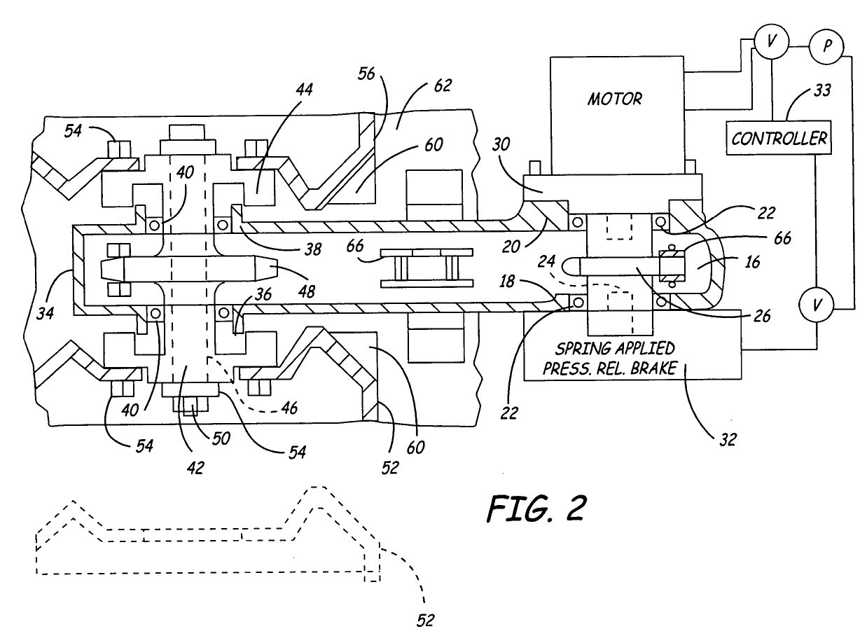

Referring to FIG. 1, a crawler drive frame 10 is shown only schematically, and it is used to mount a chain drive case housing 12 that is suitably supported with ears or braces such as those shown at 14, back to the frame 10. The chain drive case 12 is long and narrow, as can be seen in FIG. 2, and has a first end portion forming a drive sprocket support indicated at 16. The crawler drive frame 10 is mounted on a loader frame, such as a skid steer loader or tractor.

As shown in FIG. 2, suitable hubs 18 and 20 are formed on the chain housing at one end for supporting bearings 22 that in turn rotatably mount a sleeve or shaft 24 that supports a track drive sprocket 26. The sleeve or shaft 24 is internally splined, and a drive hydraulic motor 28 has a splined output shaft that fits into the splined sleeve or shaft 24 and is mounted onto the outer exterior side of hub 20 using a suitable motor flange 30 and capscrews. The motor is controlled by an operator controlled valve 27 or by a variable displacement pump.

At the opposite end of the sleeve or shaft 24, a spring applied, pressure released disc brake assembly 32 is secured to the chain case or housing in a suitable manner, and it has an input disc brake shaft that is splined, and fits into the opposite end of the sleeve or shaft 24 from the motor shaft.

The spring applied pressure released brake 32 is suitably controlled with a valve 31 from a pressure source or pump 29 as shown schematically. The valve 31 can be automatically operated with a controller 33 so that when the operator is properly positioned and secured with provided restraints, the brake would be pressurized and released. Otherwise, the brake is applied to prevent movement of the motor and track when the operator is not present or the engine is shut down. A manual operator switch can lock the brake as well.

The sprocket 26 can be a relatively small sprocket, for example, a 9-tooth sprocket. The opposite end 34 of the chain drive case or housing 12 also has hubs 36 and 38 thereon that mount bearings 40. The bearings 40 are used for rotatably mounting drive wheel section hubs 42 and 44 that are drivably mounted on a center cross shaft 46. The center cross shaft 46 passes through the hubs 42 and 44 and across the drive chain case or housing. The shaft also extends through the hub of a larger driven sprocket 48 (for example, a 17-tooth sprocket) that is drivably mounted on the shaft 46.

The shaft 46 can be splined, so that there is a drive from the shaft 46 to the sprocket 48 and both of the hubs 42 and 44 are driven. As can be seen, suitable washers and capscrews 50 can be used for holding the hubs 42 and 44 and the sprocket 48 in an assembly.

The hub 42 mounts a first half of a drive track wheel, called a drive wheel section or segment 52, which can be a metal stamping, and which has suitable openings for receiving lug bolts 54 for holding it onto the hub 42. A second drive wheel section or segment 56 comprising a half of a drive wheel, is mounted on hub 44, with lug bolts 54, and will rotate with the hub 44. Each of the drive wheel sections or segments 52 and 54 is provided with interior track drive lugs or bars 60 that can be formed from stamped metal, as can the rest of the drive wheel. The lugs 60 are used for effecting a drive to a rubber track 62 that is shown in FIG. 1. The rubber track 62 has centering lugs 64 that fit between the drive wheel sections or segments 52 and 54, as shown schematically in FIG. 2 as well. These lugs 64 on the track are engaged and driven by the lugs 60 of the drive wheel section.

A chain 66 is used for drivably connecting the sprockets 26 and 48, so that the track can be driven. The drive chain case or housing 12 can be made enclosed and sealed, and can be filled with oil that flows through the drive chain case in the desired manner.

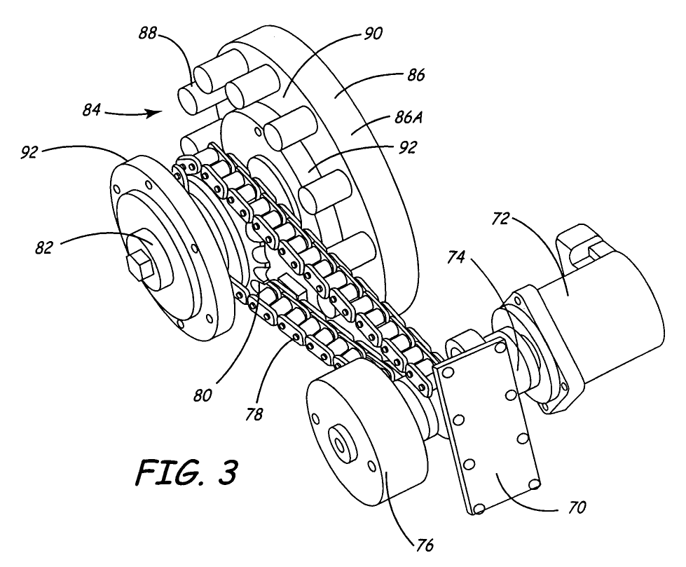

FIG. 3 is a perspective view of a chain drive with the chain case broken away for illustrative purposes. A chain case base 70 is illustrated, and the chain case extends forwardly as shown in FIG. 2. In this instance, the drive motor 72 is provided on one side to drivably couple to an input shaft 74 that is rotatably mounted on this drive chain case in a suitable manner. The spring applied, pressure released brake 76 is mounted at the opposite end of the drive shaft 74. The chain 78 is provided over a drive sprocket on the shaft 74, driven in a suitable manner, and it in turn drives a driven sprocket 80 that is mounted onto a cross shaft and hub assembly 82 as previously shown. In this form of the invention, the drive wheel assembly is indicated at 84, but only one of the drive wheel sections 86 is illustrated. The drive wheel section 86 is a wheel having a flange 86A that runs against the interior surface of a track, and serves as a support for the track and also a guide to keep the track centered when the lugs on the track are engaging drive bars 88 that are extending inwardly from a radial plate 90 of the drive wheel section 86.

As shown, a mounting hub 92 that has a bolt circle for bolting on the radial flange 90 is provided. The drive wheel section that would mount onto the hub 92 is not shown.

FIG. 3 is an illustrative example of a different type of drive wheel section that can be utilized with the drive chain case of the present invention for driving lugs on a track.

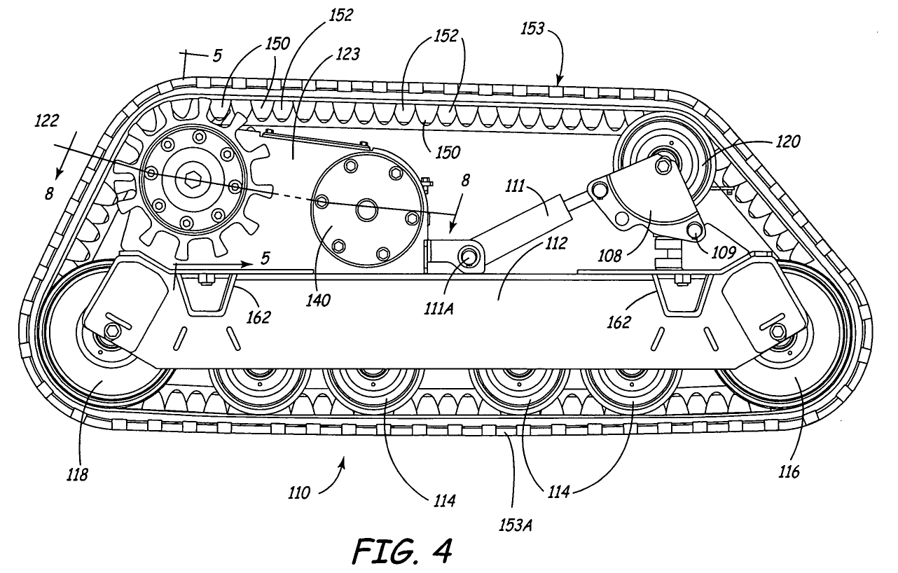

FIG. 4 illustrates another embodiment of the track assembly illustrated generally at 110. Track assembly 110 mounts onto the sides of a vehicle frame, such as a loader frame or tractor frame, and will provide a track drive for the vehicle to which it is attached. It includes a track frame shown partially at 112, that supports bogie wheels 114 at the ground engaging lower length 153A of the track 153. The bogie wheels 114 are rotatably mounted and provide guides for holding the track centered as the track is driven. The track assembly also includes a front lower idler wheel 116, a rear lower idler wheel 118, and an upper front idler track tension adjusting wheel 120. A track drive wheel assembly of this embodiment is shown at 122.

The track tensioning idler 120 is mounted onto a frame 108 that is pivotally mounted as at 109 to the track frame 112, and includes a hydraulic actuator 111 that can be utilized for creating a force to pivot the frame 108 to provide an adequate tension in the track. The hydraulic actuator is anchored at the frame 112 on a bracket and pin 111A.

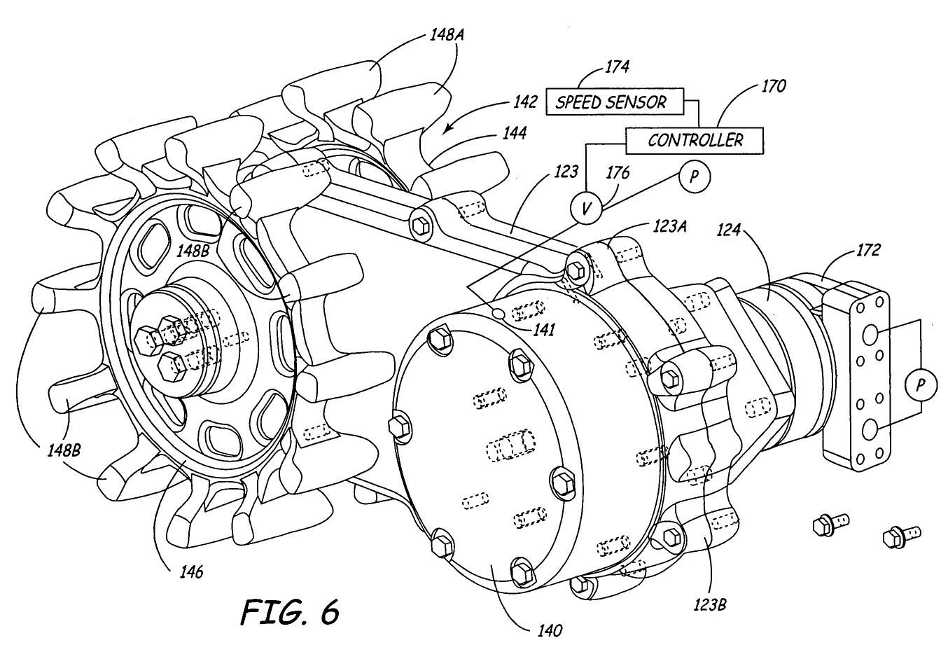

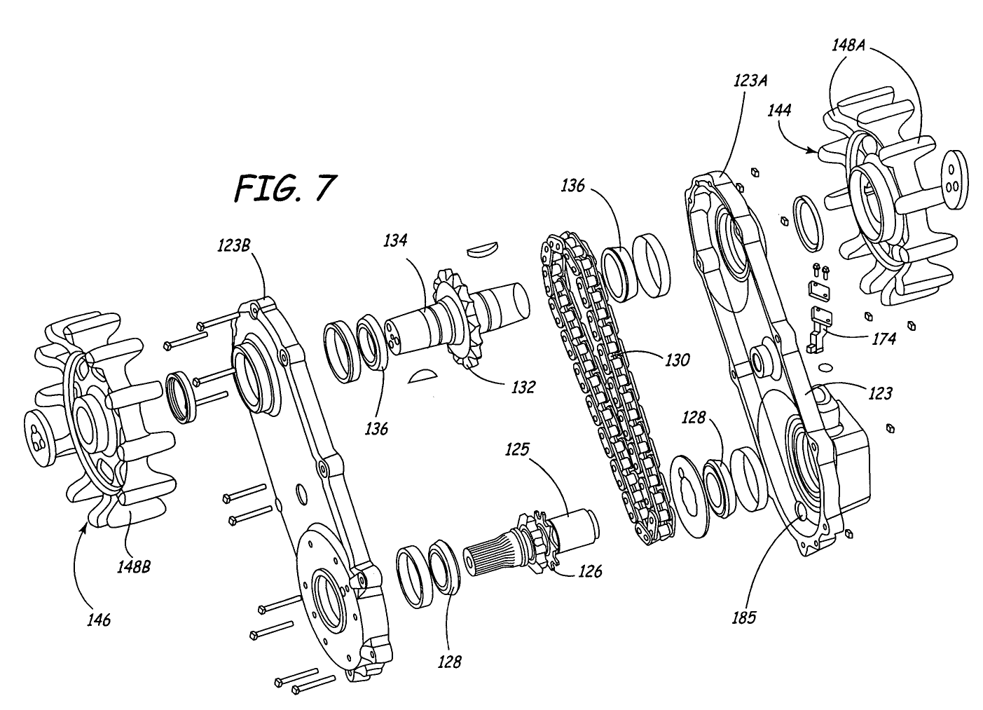

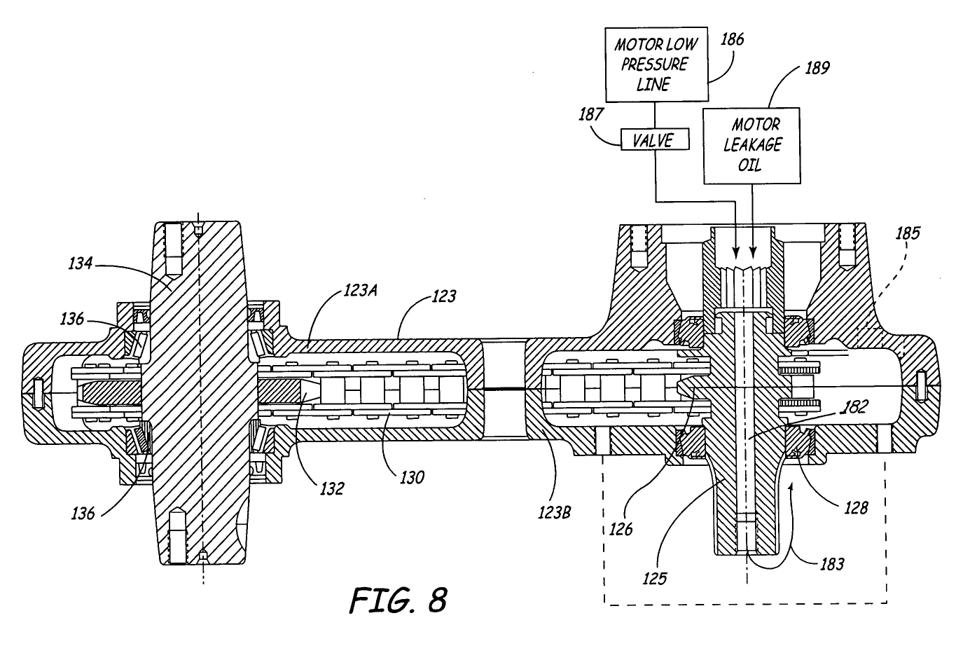

FIG. 6 is a perspective view of a drive chain drive case 123, and the drive chain case has a motor 124 mounted on one side thereof. As shown in FIGS. 7 and 8, a drive shaft 125 which mounts a drive sprocket 126 in the center of the drive chain case is rotatably mounted on the chain case 123 on suitable bearings 128. The bearings 128 are on opposite sides of the chain case.

The sprocket 126 drives a chain 130 that extends through the drive chain case and in turn chain 130 drives a larger sprocket 132 that is drivably mounted onto a shaft assembly 134. The shaft assembly is mounted on suitable bearings 136 in the chain case 123. It should be noted in FIG. 7 that the chain case is a split chain case and includes sections 123A and 123B that are bolted together for use.

Shaft assembly 134 has the sprocket 132 fixed thereon (welded or machined with the shaft) for driving, and sprocket 126 is also machined in place on shaft 125. As shown in FIG. 6, the end of shaft 125 outside of the drive chain case 123 and opposite from motor 124 has a spring applied, pressure released brake 140 drivably mounted thereon with the outer housing of the brake bolted to the chain case section 123B. The spring applied brake is released by pressurizing a hydraulic actuator port 141. The spring applied, pressure released brake is a known brake assembly. In addition to the friction brake shown, a positive mechanical stop can be utilized. A plunger that acts to intercept lugs on a rotating wheel on the motor drive shaft can be used.

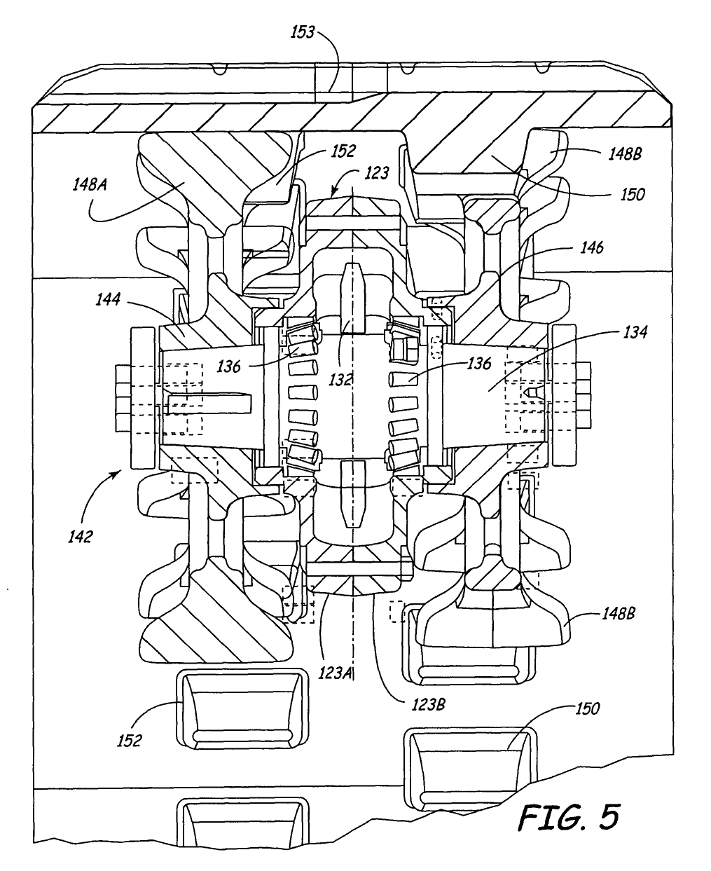

The shaft 134 protrudes from the chain case assembly 123 on opposite sides thereof, as can be seen in FIGS. 5 and 8, and the outer ends of shaft 134 mount a drive wheel assembly 142. The drive wheel assembly includes two separate drive wheel sections, including a section 144 that is on the side of the drive chain case section 123A, and a drive wheel section 146 which is on the side of the drive chain case section 123B. The drive wheel sections have hubs that are drivably mounted onto the tapered ends of the shaft 134 so that they will be rotationally driven when the sprocket 132 is driven.

The drive wheel sections have outer transversely extending drive bars 148A and 148B thereon. The drive bars 148A are on the drive wheel section 144 and the drive bars 148B are on the drive wheel section 146. These drive bars are positioned so that they will engage lugs shown at 150 and 152 in FIG. 5 on the track 153 that is used. The track 153 in the form shown, has the drive lugs 150 and 152 in longitudinal rows, and the lugs in one row are offset one-half the pitch from the other. The track lugs can be directly aligned transversely. Other types of drives shown can be used with the drive chain case speed reduction shown. The split set two drive wheel sections of a drive wheel assembly permit the drive chain case to be mounted on the interior of the track periphery.

The chain drive case 123 is mounted on the interior of the periphery of the track, as shown, that is, within the track enclosure. The drive chain case is mounted on the track frame 112. The track frame 112 includes an inverted channel 160 that supports the bogie wheels and idler wheels for track 153. Cross members 162 are secured to the inverted channel 160 (see FIG. 4 also) and extend laterally so they mount to a frame of a vehicle 164 in a suitable manner. The drive chain case can be bolted to the inverted channel 160 or attached to the channel, and thus supported relative to the frame of the vehicle, using suitable brackets.

The chain drive permits speed reduction, and a much smaller, but high speed, motor can be utilized and still obtain the necessary torque for driving, when compared to the motors used for a direct track wheel drive. Also, a smaller brake can be used.

The motor 124 is a hydraulic motor controlled by a controller 170 that controls a valve 172 to obtain the desired speed of the motor, as shown. A wheel speed sensor 174 can be used primarily to sense inadvertent actuation of the drive motor. If motor is secured when not demanded by the operator, the controller will lock the parking brake. The speed of drive wheel 142 also can be secured. The controller also controls a valve 176 for the brake actuator port 141 so when the operator is not stationed or the loader on other vehicle is parked, the brake is applied or on. The brake is a parking brake only.

While the drawings show a track with the drive wheel at the top of the track, the chain drive case with the chain speed reduction can also be utilized where the drive wheel or wheels are at the lower side of the track. Any desired location for the drive wheel can be accommodated with the present drive chain case design.

The drive chain case mounted within the track does require the use of a split drive wheel, with lugs that are matching the position of the drive wheels on the track. However, tracks that have bars or lugs that go all the way across the track can be utilized as well, because the wheels are still capable of being split and driving on a continuous lug that extends laterally across the track.

The guide wheels for holding the track in position can be mounted at the edges of the track, that is, one on each side, for bogie wheels and guide wheels, and a roller that has a central wheel that would also serve as a guide between the lower lugs can be utilized when the lugs are split into two rows as shown herein. The illustrations herein show the drive with an all rubber positive drive track, but the speed reduction drive chain case also can be used with the embedded iron core crossbar tracks as well as friction drive tracks. However, the drive chain case would be mounted along the center plane of the track and the drive wheel sections are on the sides of this case.

When the motor 28 or 124 is driven, and drives sprocket 26 or 126, it can be seen that a speed reduction takes place to the drive hubs 42 and 44 and shaft 134. That means that a smaller motor, which rotates at a higher speed than the drive wheel, can be used.

The spring applied pressure release brake will be used for stopping the track whenever it is desired, either by a manual input, or automatically, as shown. The drive chain case can be pivoted to the frame 112 in a manner that will permit using it for track tensioning by using a pivot and springs that urge the chain case to move to a position increasing the track tension.

It can be seen that the drive chain case itself is between the track drive wheel sections, so that the drive chain case acts as a block or scraper to remove mud from the track drive wheel sections as the drive wheel rotates.

The motor shaft is spaced from the track drive wheel shaft where dirt and debris may be ingested, so that the motor is not susceptible to ingest dirt that comes directly from the track drive wheel.

It can be seen that track drive wheel sections can be removed, as shown in dotted lines in FIG. 2, for installation and removal of the track. The track also has exterior traction lugs as is conventional.

The sprockets and chain in the drive chain case can be replaced with V-belts and pulleys, or cogged belts and pulleys, if desired. Sprockets and pulleys are both drive wheels, and chains and belts are endless flexible drive members between the input and output shafts of the drive chain case.

Also schematically shown in FIGS. 7 and 8 is a flow through oil arrangement for the drive chain case. The hydraulic motor has normal leakage of hydraulic oil and this leakage oil 189 is directed through a bore 186 in shaft 125. Also, the low pressure line or return line from the motor represented at 186 can have a shuttle valve 187 therein (integral with the motor) that directs a low flow, for example, 1 to 2 gallons per minute to the bore 182. The oil flows out the end of shaft 125 into the case for the brake 140 as shown by arrow 183 and back to the case 123 through bearings 128 or suitable ports. The oil in the case 123 can be kept at the desired level (to ensure oil in the case 123 for the chain and sprockets) by location of a drain port 185. The oil then flows back to the hydraulic oil tank. The oil also lubricates the spline drive from the motor 124 to shaft 125. Other oil flow through arrangements can be made as well.

Although the present invention has been described with reference to preferred embodiments, workers skilled in the art will recognize that changes may be made in form and detail without departing from the spirit and scope of the invention.

What is claimed is:

1. A track drive system for a continuous enclosed ground drive track comprising a track frame mounted inside the track periphery;
a plurality of guide wheels on the track to maintain the track in a desired closed path of movement;
said wheels including a track drive wheel assembly, said track drive wheel assembly having a pair of track drive wheel sections;
a drive case supported relative to the track drive frame and having an input shaft and an output shaft;
the track drive wheel sections being mounted on portions of the output shaft extending from the opposite sides of the drive case;
an input shaft mounted on the drive case and spaced from the output shaft;
a drive motor on the input shaft to rotate the input shaft; and
an endless flexible drive member operable between the input shaft and the output shaft of the drive case to drive the track drive wheel when the motor is driven.

2. The track frame assembly of claim 1, wherein said flexible drive member comprises a speed reduction drive between the input shaft and the output shaft.

3. The track drive assembly of claim 2 and a brake on an opposite end of the input shaft from the motor, said brake being normally engaged for braking action, and being relievable under application of pressure to release the input shaft for rotation.

4. The track drive assembly of claim 1, wherein said drive case is an enclosed drive case, and a supply of oil connected to the drive case.

5. The track drive assembly of claim 2, wherein the brake is a spring applied, pressure released brake and is connected to a controller to release the brake when selected conditions have occurred.

6. A speed reduction drive for a crawler track, mounted on supports to move in an endless path to form a periphery and an interior space, including a ground support length, a drive wheel assembly for driving the track, said drive wheel assembly including a drive shaft, a housing mounting said drive shaft with the drive shaft having end portions extending outwardly on opposite sides of the housing, the housing being supported relative to a vehicle frame, and the housing being on the interior space of the crawler track mounted on said supports, said drive wheel assembly including separated drive wheel sections, one of the drive wheel sections being on each of the opposite outwardly extending ends of the drive shaft on the exterior of the housing, an input shaft mounted on said housing at a position spaced from the drive shaft, a motor to drive said input shaft from a position on the interior of the periphery of the crawler track, the input shaft and the output shaft having drive wheels thereon, and an endless drive member between the drive wheels of the input shaft and the output shaft, the input shaft having a smaller drive wheel than that on the output shaft to provide for a speed reduction from the input to output shafts.

7. The speed reduction drive of claim 6, wherein said endless member comprises a chain, and said drive and driven wheels comprise sprockets on which the chain is mounted.

8. The speed reduction drive of claim 6, wherein said housing has an elongated shape, and a width that is substantially less than the width of the crawler track, said track drive wheel sections engaging lugs on said track, said lugs being engaged by the track drive wheels at laterally spaced locations from a center plane of the crawler track.

9. The speed reduction drive of claim 8, wherein said motor comprises a hydraulic motor coupled to a first end of said input shaft on an outwardly extending portion of the input shaft that extends outwardly from said housing, said input shaft having a second end that extends out from the housing, and a brake member attached to said second end, said brake member being released when selected conditions occur.

10. The speed reduction drive of claim 9, wherein said brake comprises a spring applied brake that normally will apply a braking force to the input shaft, and a hydraulic pressure actuator for releasing the brake when selected conditions occur.
